(19) United States
(12) Patent Application Publication
(10) Pub. No.: US 2015/0205565 A1
(43) Pub. Date: Jul. 23, 2015

(54) MULTI-SCREEN DISPLAY SYSTEM AND DISPLAY METHOD

(71) Applicant: NEC Display Solutions, Ltd., Minato-ku, Tokyo (JP)

(72) Inventor: Hiroaki Koguchi, Tokyo (JP)

(73) Assignee: NEC Display Solutions, Ltd., Minato-ku,Tokyo (JP)

(21) Appl. No.: 14/415,083

(22) PCT Filed: Jul. 19, 2012
(86) PCT No.: PCT/JP2012/068266

§ 371 Date: Jan. 15, 2015

(51) Int. Cl. G06F 3/14

(52) U.S. Cl. CPC G06F 3/1446; G09G 2330/08; G09G 2330/12; G09G 2340/0464; G09G 2300/026

(57) ABSTRACT

A multi-screen display system has a plurality of closely arranged display devices. A master device that is one of the display devices has a detection unit which detects that any of the display devices in the multi-screen display system has become not able to perform display; and a display control unit that controls display operation of the individual display devices according to a display method associated with a position in the multi-screen display system of each display device detected by the detection unit.

### TECHNICAL FIELD

The present invention relates to a multi-screen display system and a display method.

### BACKGROUND ART

Recently, a multi-screen display system is known in which a plurality of display devices are joined and electrically connected with each other to perform large-screen display for advertisements or the like (see, for example, Patent Document 1). In the multi-screen display system, a single video source is enlarged and divided images are displayed by the plurality of the display devices so as to implement the large-screen display.

### PRIOR ART DOCUMENT

### Patent Document

Patent Document 1: Japanese Unexamined Patent Application, First Publication No. 2009-294574.

### DISCLOSURE OF INVENTION

### Problem to be Solved by the Invention

However, in the technique disclosed by Patent Document 1, if part of the display devices cannot perform the display due to an error or failure, part of the entire image is not displayed and information to be communicated cannot be sufficiently displayed.

That is, a problem to be solved is that when part of the display devices becomes not able to perform the display, part of the entire image is missing in the large display.

In light of the above circumstances, an object of the present invention is to provide a multi-screen display system and a display method, by which even when part of the display devices becomes not able to perform the display, the entire image can be accurately displayed.

### Means for Solving the Problem

The present invention provides a multi-screen display system having a plurality of display devices connected with each other, one of which is a master device that comprises:

a detection unit which detects that any one or more of slave devices, which are the display devices other than the master device, are not able to perform display; and

a display control unit that controls display operation of the individual display devices according to a display method associated with a position in the multi-screen display system of each slave device detected by the detection unit.

The present invention also provides a display method utilized in a multi-screen display system having a plurality of display devices connected with each other, the method comprising:

a step in which a master device, that is one of the display devices, detects that any one or more of slave devices, which are the display devices other than the master device, are not able to perform display; and

a step in which the master device controls display operation of the individual display devices according to a display method associated with a position in the multi-screen display system of each detected slave device.

### Effect of the Invention

According to the present invention, even when part of the display devices becomes not able to perform the display, the entire image can be accurately displayed.

### BRIEF DESCRIPTION OF THE DRAWINGS

FIG. 1 is a block diagram for an embodiment of the present invention and shows the structure of a multi-screen display system.

FIG. 2 is a diagram utilized to generally explain a positional relationship between display devices that form the multi-screen display system in the present embodiment.

FIG. 3 is a block diagram that shows a functional structure of a master device in the present embodiment.

FIG. 4 is a block diagram that shows a functional structure of a slave device in the present embodiment.

FIG. 5 is a diagram that generally shows the data structure and an example of the data of a control rule table stored in each storage unit of the present embodiment.

FIG. 6 is a flowchart that shows the procedure of a display operation executed by the master device in the present embodiment.

FIG. 7 is a flowchart that shows the procedure of a display operation executed by the slave device in the present embodiment.

FIG. 8 is a schematic diagram that shows an example of display utilizing the multi-screen display system of the present embodiment.

FIG. 9 is a schematic diagram that shows an example of display utilizing the multi-screen display system when any display device has become not able to perform display in the present embodiment.

FIG. 10 is a schematic diagram that shows another example of display utilizing the multi-screen display system when any display device has become not able to perform display in the present embodiment.

FIG. 11 is a schematic diagram that shows another example of display utilizing the multi-screen display system of the present embodiment.

FIG. 12 is a schematic diagram that shows another example of display utilizing the multi-screen display system when any display device has become not able to perform display in the present embodiment.

FIG. 13 is a schematic diagram that shows another example of display utilizing the multi-screen display system when any display device has become not able to perform display in the present embodiment.

### MODE FOR CARRYING OUT THE INVENTION

Below, embodiments for carrying out the present invention will be explained in detail with reference to the drawings.

First, the following terms to be used in the following explanation are defined.

“Nondisplay” denotes a state in which an image corresponding to a video signal cannot be displayed, for example, when the power is off due to a failure or an operation, or when an error or failure occurs which causes the state in which an image corresponding to a video signal cannot be displayed.

In addition, “displayable state” denotes a state in an image corresponding to a video signal can be displayed.

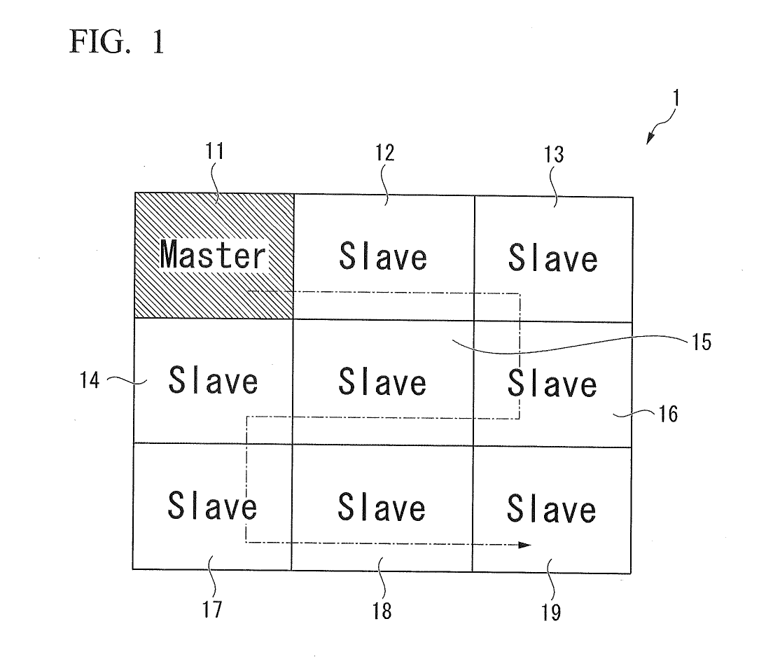

FIG. 1 is a block diagram for an embodiment of the present invention and shows the structure of a multi-screen display system 1.

In the multi-screen display system 1, a plurality of display devices are connected in a manner such that they are placed near so as to communicate with each other. For example, a total of nine (3×3) display devices (three in the horizontal direction and three in the vertical direction) are connected to form the system. The multi-screen display system 1 enlarges an image in accordance with a video signal and makes the display devices display divided images of the image so as to perform large-screen display. The multi-screen display system 1 includes a master device 11 and a plurality of slave devices 12, 13, 14, 15, 16, 17, 18, and 19 (below, generally called “slave devices 12 to 19”).

The master device 11 and the slave devices 12 to 19 are each a display device, for example, a liquid crystal display device or a plasma display that displays an image corresponding to a video signal. The master device 11 and the slave devices 12 to 19 are connected in a daisy chain manner in order of the master device 11, the slave device 12, the slave device 13, the slave device 16, the slave device 15, the slave device 14, the slave device 17, the slave device 18, and the slave device 19. That is, the master device 11 is a display devise as the head of the daisy chain connection in the multi-screen display system 1. Here, master/slave setting between the daisy-chain-connected display devices can be performed utilizing an external control terminal (e.g., RS232C terminal, remote control terminal, or LAN (Local Area Network) terminal) provided at each of the master device 11 and the slave devices 12 to 19.

In addition, the master device 11 receives a video signal to be displayed by the multi-screen display system 1 and sends the received video signal to the slave device 12 on the right side of the master device 11. The slave device 12 receives the video signal from the master device 11 and sends the received video signal to the slave device 13 on the right side of the slave device 12. The slave device 13 receives the video signal from the slave device 12 and sends the received video signal to the slave device 16 on the lower side of the slave device 13.

The slave device 16 receives the video signal from the slave device 13 and sends the received video signal to the slave device 15 on the left side of the slave device 16. The slave device 15 receives the video signal from the slave device 16 and sends the received video signal to the slave device 14 on the left side of the slave device 15. The slave device 14 receives the video signal from the slave device 15 and sends the received video signal to the slave device 17 on the lower side of the slave device 14.

The slave device 17 receives the video signal from the slave device 14 and sends the received video signal to the slave device 18 on the right side of the slave device 17. The slave device 18 receives the video signal from the slave device 17 and sends the received video signal to the slave device 19 on the right side of the slave device 18.

For nine images obtained by dividing an image corresponding to the received video signal into nine pieces (here, three sections in the horizontal direction and three sections in the vertical direction), the master device 11 and the slave devices 12 to 19 display the divided images in an enlarged manner, where each device displays a divided image corresponding to the arrangement position of the relevant device in the multi-screen display system 1. Accordingly, the entire set of the display devices can display one image corresponding to a video signal.

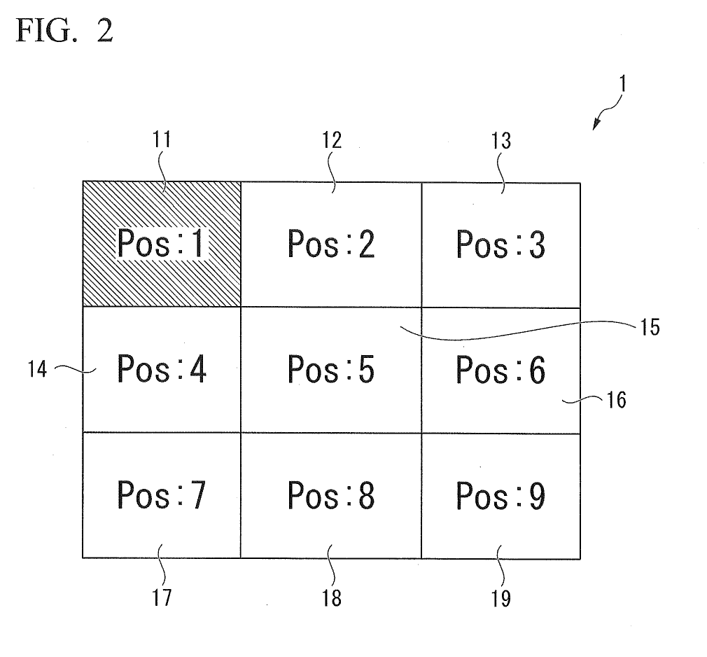

FIG. 2 is a diagram utilized to generally explain a positional relationship between the display devices that form the multi-screen display system 1.

The slave device 12 is disposed on the right side of the master device 11, and the slave device 13 is disposed on the right side of the slave device 1. The slave device 14 is disposed on the lower side of the master device 11, the slave device 15 is disposed on the right side of the slave device 14, and the slave device 16 is disposed on the right side of the slave device 15. The slave device 17 is disposed on the lower side of the slave device 14, the slave device 18 is disposed on the right side of the slave device 17, and the slave device 19 is disposed on the right side of the slave device 18.

Here, position IDs (Identifications) are allocated to individual display devices (which form the multi-screen display system 1) in accordance with the arrangement positions in the multi-screen display system 1. Therefore, the position IDs are identification information items that indicate the individual arrangement positions. The master device 11 and the slave devices 12 to 19 store the position IDs of themselves. Additionally, the master device 11 stores the position IDs of the slave devices 12 to 19. The position IDs can be set utilizing control terminals provided at the master device 11 and the slave devices 12 to 19.

In the shown example, the position ID of the master device 11 is 1, the position ID of the slave device 12 is 2, the position ID of the slave device 13 is 3, the position ID of the slave device 14 is 4, the position ID of the slave device 15 is 5, the position ID of the slave device 16 is 6, the position ID of the slave device 17 is 7, the position ID of the slave device 18 is 8, and the position ID of the slave device 19 is 9.

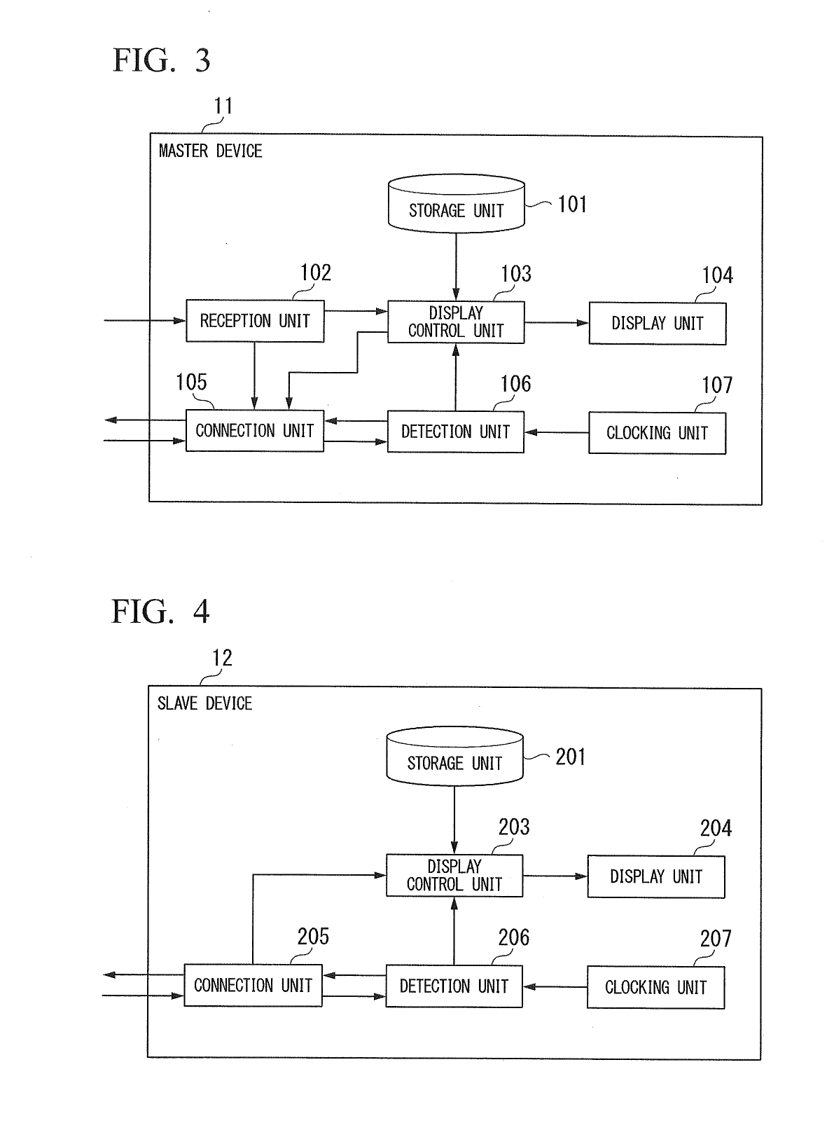

FIG. 3 is a block diagram that shows a functional structure of the master device 11. The master device 11 has a storage unit 101, a reception unit 102, a display control unit 103, a display unit 104, a connection unit 105, a detection unit 106, and a clocking unit 107 that counts time.

The storage unit 101 stores the individual position IDs of the display devices, which form the multi-screen display system 1, and a control rule table. In the control rule table, the individual positions (i.e., position IDs) of the display devices in the multi-screen display system 1 are associated with information items that indicate corresponding display methods utilized when the “Nondisplay” state occurs. For example, in the control rule table, the position ID of a “Nondisplay” display device is associated with information that shows a display method for the device.

The reception unit 102 receives a video signal and outputs the received video signal to the display control unit 103 and the connection unit 105.

The display control unit 103 controls display operation of the master device 11 and the slave devices 12 to 19. For example, the display control unit 103 displays an image corresponding to the input video signal on the display unit 104. Specifically, the display control unit 103 divides the image corresponding to the input video signal into pieces based on the number and arrangement of the display devices that belong to the multi-screen display system 1 (e.g., division of three sections in the horizontal direction and three sections in the vertical direction) and enlarges and displays the upper-left image piece on the display unit 104.

Additionally, when identification information about the slave devices 12 to 19 is received from the detection unit 106, the display control unit 103 controls display operation of the individual display devices of the multi-screen display system 1 in accordance with the display method corresponding to the position ID of the input identification information. More specifically, the display control unit 103 retrieves the position ID associated with the input identification information from the storage unit 101 and also retrieves a display method, that corresponds to the retrieved position ID, from the control rule table. Based on the retrieved display method, the display control unit 103 displays the image corresponding to the video signal on the display unit 104. In addition, the display control unit 103 sends a redisplay command signal, that commands redisplaying operation, to the slave devices 12 to 19. The redisplay command signal includes the retrieved display method and a display control signal based on the display method. For example, the redisplay command signal represents how to display the relevant video utilizing the display devices other than the “Nondisplay” display device (i.e., one of the display devices of the multi-screen display system 1). The display control signal is a signal utilized to control the display operation of the individual display devices and includes a command to activate the multi-screen display, a command to turn the power off, an instruction about whether or not monochromatic display is performed, and the like. The command to activate the multi-screen display includes an instruction about which part of the image corresponding to the video signal is to be enlarged.

The display unit 104 displays the image corresponding to the video signal from the display control unit 203.

The connection unit 105 is a connector utilized to connect and communicate with the other display devices (the slave devices 12 to 19). For example, the connection unit 105 sends the video signal, that was received from the reception unit 102, to the slave devices 12 to 19.

The detection unit 106 detects a state in which any one of the display devices (the master device 11 and the slave devices 12 to 19) in the multi-screen display system 1 has entered the Nondisplay state and outputs the identification information for the detected “Nondisplay” display device (the master device 11 or one of the slave devices 12 to 19) to the display control unit 103. More specifically, the detection unit 106 sends a Nondisplay detection signal utilized to detect the “Nondisplay” display device to the slave devices 12 to 19 at regular intervals and detects the “Nondisplay” display device based on responses of the individual display devices. For example, based on response signals for the Nondisplay detection signal, which are sent from the slave devices 12 to 19, the detection unit 106 detects the “Nondisplay” display device (i.e., any of the slave devices 12 to 19). Each response signal includes the identification information of the relevant slave device (12, . . . , or 19) and a status. The status is data that indicates the state of the display device and includes a state about the multi-screen display, an error state (i.e., whether or not an error has occurred), a power state, and the like. In addition, the detection unit 106 may send the Nondisplay detection signal to the display devices 12 to 19 and receive response signals, that indicate that normal display operation is performed, from the individual display devices so as to determine that each display device that has sent the response signal is in the displayable state while any display device that has not sent the response signal is in the Nondisplay state.

FIG. 4 is a block diagram that shows a functional structure of the slave device 12.

The master device 12 has a storage unit 201, a display control unit 203, a display unit 204, a connection unit 205, a detection unit 206, and a clocking unit 207 that counts time.

The storage unit 201 stores the position IDs of itself and a control rule table.

The display control unit 203 displays an image corresponding to the video signal received from the connection unit 205 on the display unit 204. For example, based on the arrangement position (corresponding to the position ID) of the present device in the multi-screen display system 1, the display control unit 203 enlarges and displays part of the image corresponding to the received video signal on the display unit 204. When receiving the redisplay signal via the connection unit 205, the display control unit 203 redisplays the image corresponding to the video signal in accordance with the display method and the display control signal which are included in the received redisplay signal. In addition, when receiving the identification information about the “Nondisplay” master device 11 from the detection unit 206, the display control unit 203 retrieves the display method corresponding to the position ID “1” of the master device 11 from the control rule table in the storage unit 201. Based on the retrieved display method, the display control unit 203 displays the image corresponding to the video signal on the display unit 204.

The display unit 204 displays an image corresponding to a video signal from the display control unit 203.

The connection unit 205 is a connector utilized to connect and communicate with the other display devices (the master device 11 and the slave devices 12 to 19). For example, the connection unit 205 receives a video signal and sends the received video signal to the other display devices (i.e., the slave devices 13 to 19). The connection unit 205 also receives the redisplay signal and outputs the received redisplay signal to the display control unit 203. Additionally, the display control unit 203 receives the Nondisplay detection signal from the master device 11 and outputs the received Nondisplay detection signal to the detection unit 206.

When receiving the Nondisplay detection signal from the connection unit 205, the detection unit 206 performs self-diagnosis to obtain a status of the present device and sends a response signal, that includes the obtained status and the identification information of the present device, to the master device 11. If the Nondisplay detection signal has not been received for a predetermined period of time, the detection unit 206 determines that the master device 11 is in the Nondisplay state, and the detection unit 206 outputs the identification information of the master device 11 to the display control unit 203.

Since the functional structures of the slave devices 13 to 19 are each identical to that of the slave device 12 shown in FIG. 4, explanations thereof are omitted here.

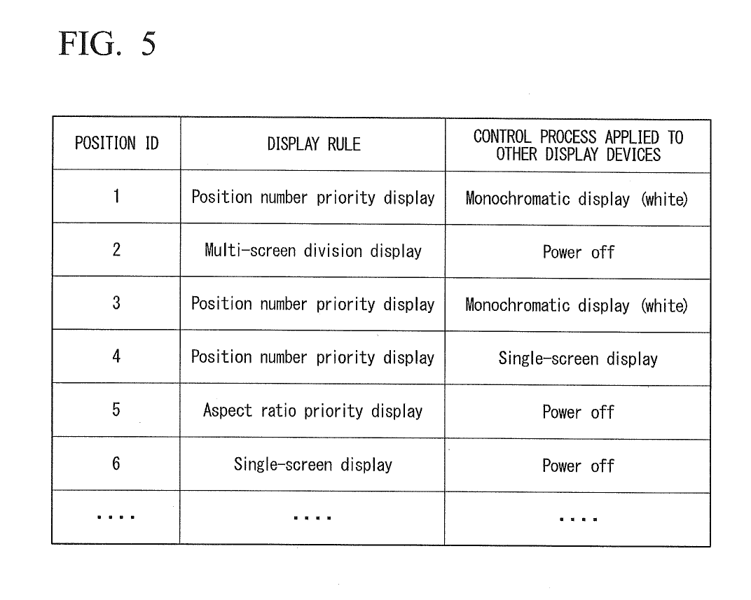

FIG. 5 is a diagram that generally shows the data structure and an example of the data of the control rule table stored in the storage unit 101 and the storage unit 201.

As shown in FIG. 5, the control rule table is a data having a two-dimensional table manner (includes rows and columns) and rows for the items such as the position ID, display rule, and control process applied to other display devices, where a row is provided for each position ID. The display rule and the control process applied to the other display devices represent each display method when the Nondisplay state occurs.

The display rule is a rule for the display performed when the display device having the relevant position ID has entered the Nondisplay state. Examples of the display rule are shown below.

In the rule called “Position number priority display”, display is performed utilizing devises selected from among “displayable” display devices, where the selected devices include one having the minimum position ID among the displayable display devices and have a less number of screens (e.g., 2×2) than the number of screens (e.g., 3×3) of the entire system.

In the rule called “Multi-screen division display”, the screen according to the video signal is divided so as to display the relevant image utilizing displayable display devices.

In the rule called “Single-screen display”, the image corresponding to the video signal is displayed on each of displayable display devices.

In the rule called “Aspect ratio priority display”, priority is given to the aspect ratio of the image corresponding to the video signal, and display is performed utilizing displayable display devises without changing the aspect ratio.

The control process applied to other display devices indicates a control process applied to display devices that display no image corresponding to the video signal (e.g., display devices that do not form the relevant multi-screen). Examples of the control method are shown below.

In the control process called “Power off”, the relevant display device is powered off.

In the control process called “Monochromatic display (white/black)”, white or black is displayed on the entire screen. Although power of the relevant display device is on (unlike in the above “Power off”), certain information (e.g., white or black over the entire screen) that differs from the video signal is displayed.

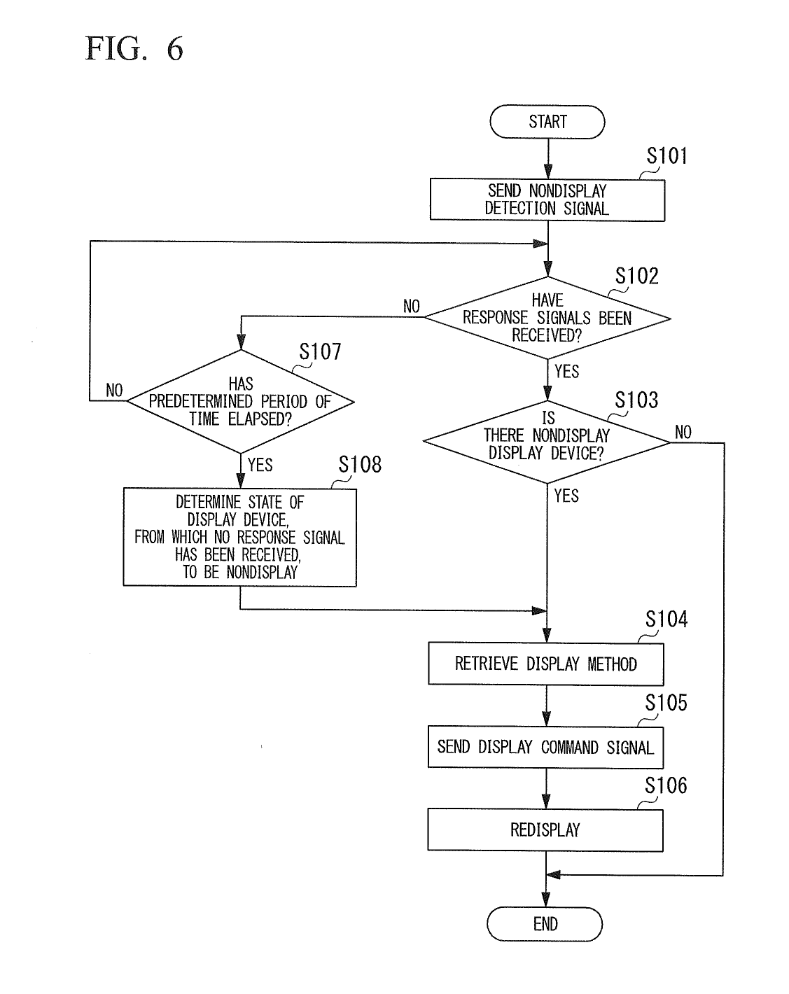

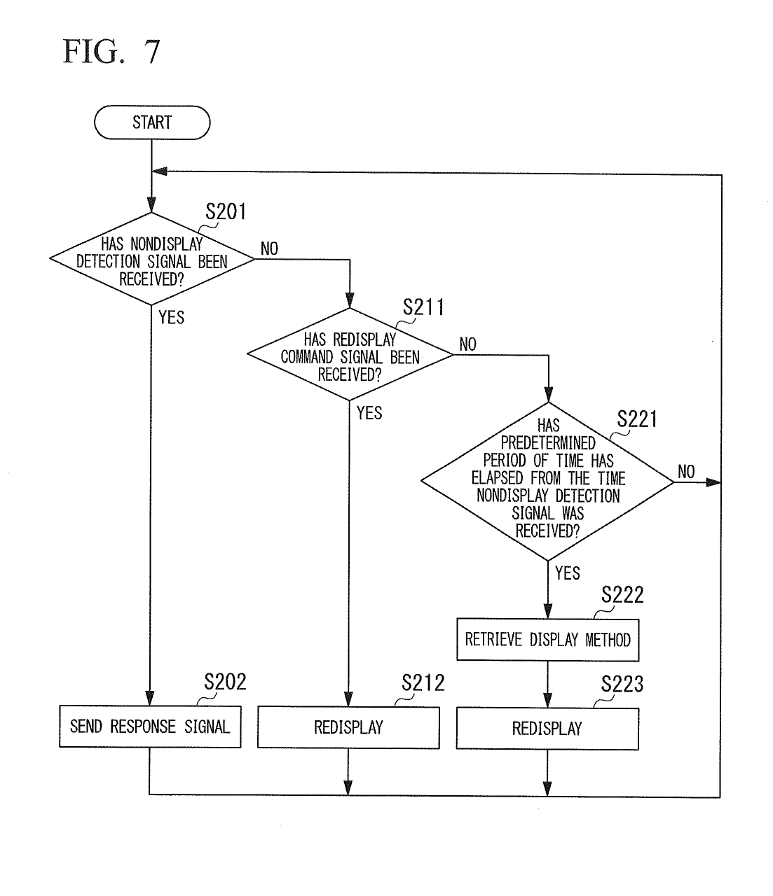

Next, with reference to FIGS. 6 and 7, display operation of the multi-screen display system 1 will be explained.

FIG. 6 is a flowchart that shows the procedure of a display operation executed by the master device 11.

The master device 11 performs the relevant display operation at regular intervals.

First, the detection unit 106 sends the Nondisplay detection signal to (each of) the slave devices 12 to 19 via the connection unit 105 (see step S101).

The detection unit 106 then determines whether or not response signals (to the sent Nondisplay detection signal) from all the slave devices 12 to 19 have been received (see step S102).

If the response signals from all the slave devices 12 to 19 have been received (i.e., “YES” in step S102), the detection unit 106 determines, based on the response signals from the individual slave devices 12 to 19, whether or not any of the display devices (here, slave devices 12 to 19) is in the Nondisplay state (see step S103). More specifically, the detection unit 106 detects each display device, whose response signal includes a status that shows occurrence of error or power-off, as the Nondisplay display device. If no Nondisplay display device has been detected (i.e., “NO” in step S103), the operation of the present flow is terminated.

On the other hand, if there is any Nondisplay display device (i.e., “YES” in step S103), the display control unit 103 retrieves a display method associated with the position ID of the Nondisplay display device from the control rule table in the storage unit 101 (see step S104).

The display control unit 103 then sends the redisplay command signal, that includes the retrieved display method, to (each of) the slave devices 12 to 19 (see step S105).

In addition, the display control unit 103 redisplays the image corresponding to the video signal on the display unit 104 in accordance with the retrieved display method (see step S106).

If all of the response signals from the slave devices 12 to 19 has not been received (i.e., “NO” in step S102), the detection unit 106 determines whether or not a predetermined period of time has elapsed from the time the Nondisplay detection signal was sent (see step S107). If the predetermined period of time has not yet elapsed from the time the Nondisplay detection signal was sent (i.e., “NO” in step S107), the operation returns to step S102.

In contrast, if all of the response signals from the slave devices 12 to 19 has not been received though the predetermined period of time has elapsed from the time the Nondisplay detection signal was sent (i.e., “YES” in step S107), the detection unit 106 determines the state of each slave device (among devices 12 to 19), from which no response signal has been received, to be “Nondisplay” (see step S108), and the operation proceeds to step S104.

FIG. 7 is a flowchart that shows the procedure of a display operation executed by the slave devices 12 to 19.

First, the detection unit 206 determines whether or not the Nondisplay detection signal has been received (see step S201).

If the Nondisplay detection signal has been received (i.e., “YES” in step S201), the detection unit 206 obtains the status of the present device and sends a response signal, that includes the obtained status and identification information of the present device, to the master device 11 (see step S202). The operation then returns to step S201.

In contrast, if no Nondisplay detection signal has been received (i.e., “NO” in step S201), the display control unit 203 determines whether or not the redisplay command signal has been received (see step S211).

If the redisplay command signal has been received (i.e., “YES” in step S211), the display control unit 203 redisplays the image corresponding to the video signal on the display unit 204 in accordance with the display method and the display control signal which are included in the retrieved redisplay command signal (see step S212). The operation then returns to step S201.

In contrast, if the redisplay command signal has not been received (i.e., “NO” in step S211), the detection unit 206 determines whether or not a predetermined period of time has elapsed from the time the immediately preceding Nondisplay detection signal was received (see step S221). If the predetermined period of time has not yet elapsed from the time the immediately preceding Nondisplay detection signal was received (i.e., “NO” in step S221), the operation returns to step S201.

In contrast, if the predetermined period of time has elapsed from the time the immediately preceding Nondisplay detection signal was received (i.e., “YES” in step S221), the detection unit 206 determines that the master device 11 is in the Nondisplay state. Then the display control unit 203 retrieves a display method associated with the position ID “1” of the master device 11 from the control rule table in the storage unit 201 (see step S222).

According to the retrieved display method, the display control unit 203 redisplays the image corresponding to the video signal on the display unit 204 (see step S223), and the operation returns to step S201.

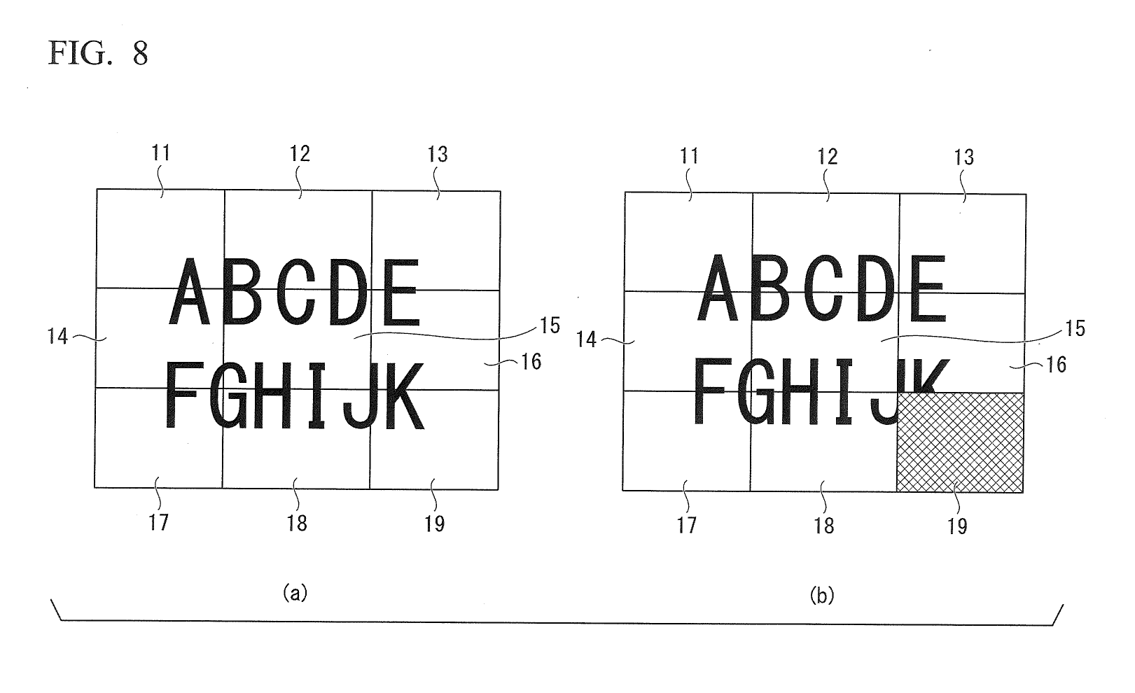

Next, with reference to FIGS. 8 to 13, specific examples for the display operation of the multi-screen display system 1 will be shown.

FIG. 8 is a schematic diagram that shows an example of display utilizing the multi-screen display system 1.

The following explanation pertains to an example in which an image having a character sequence “ABCDEFGHIJK” is to be displayed (see part (a) in FIG. 8) and the slave device 19 (whose position ID is 9) has entered the Nondisplay state (see part (b) in FIG. 8). In conventional multi-screen display systems, when the slave device 19 has entered the Nondisplay state, part of the character sequence “JK” is not displayed. Therefore, in such conventional multi-screen display systems, part of the image corresponding to the video signal is missing and information to be communicated cannot be accurately communicated.

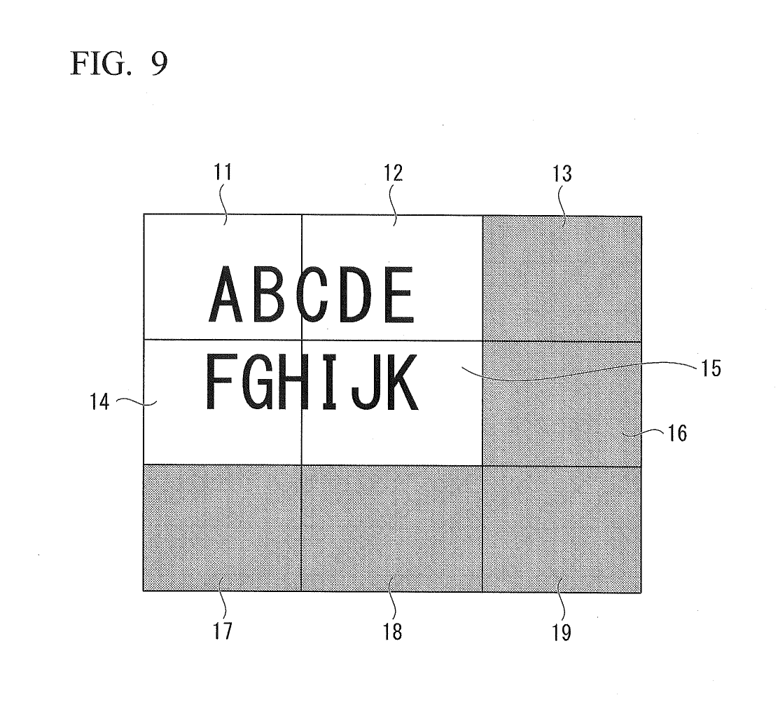

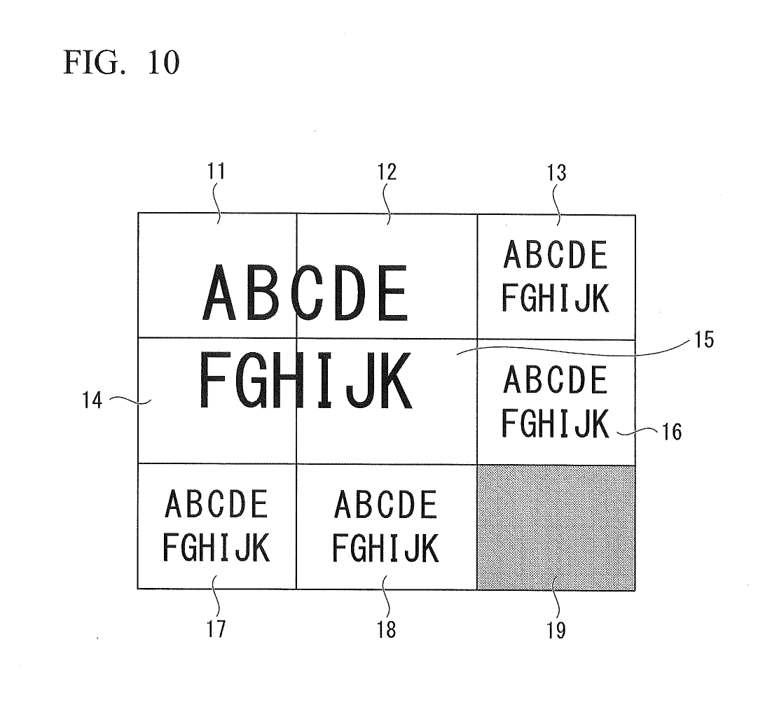

FIGS. 9 and 10 are schematic diagrams that show examples of display utilizing the multi-screen display system 1 when any display device has entered the Nondisplay state.

In the control rule table for the example of FIG. 9, the display rule associated with the position ID “9” is “Position number priority display” and the control process applied to other display devices is “Power off”.

According to the display rule called “Position number priority display”, the display control unit 103 forms a multi-screen utilizing the master device 11 and the slave devices 12, 14, and 15 and displays the image (that includes the image “ABCDEFGHIJK”) indicated by the video signal on the formed multi-screen. In addition, according to the control process applied to other display devices called “Power off”, the display control unit 103 turns off the power of the slave devices 13, 16, 17, 18, and 19 which are other display devices that do not form the relevant multi-screen.

In the control rule table for the example of FIG. 10, the display rule associated with the position ID “9” is “Position number priority display” and the control process applied to other display devices is “Single-screen display”.

According to the display rule called “Position number priority display”, the display control unit 103 forms a multi-screen utilizing the master device 11 and the slave devices 12, 14, and 15 and displays the image “ABCDEFGHIJK” indicated by the video signal on the formed multi-screen. In addition, according to the control process applied to other display devices called “Single-screen display”, the display control unit 103 displays the image “ABCDEFGHIJK” indicated by the video signal on each of the slave devices 13, 16, 17, and 18, which are other display devices that do not form the relevant multi-screen, in a single-screen manner. In this case, the slave device 19 may be powered off.

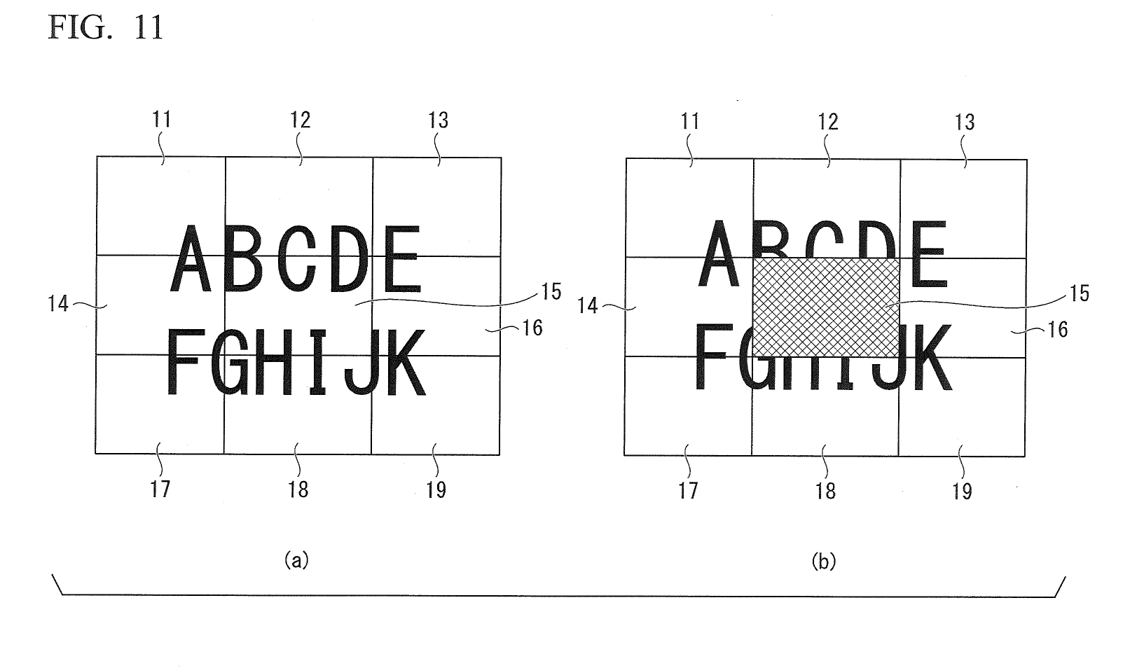

FIG. 11 is a schematic diagram that shows an example of the display utilizing the multi-screen display system 1.

The following explanation pertains to an example in which an image having a character sequence “ABCDEFGHIJK” is to be displayed (see part (a) in FIG. 11) and the slave device 15 (whose position ID is 5) has entered the Nondisplay state (see part (b) in FIG. 11). In conventional multi-screen display systems, if the slave device 15 has entered the Nondisplay state, part of the character sequence “BCD” and part of the character sequence “GHI” are not displayed.

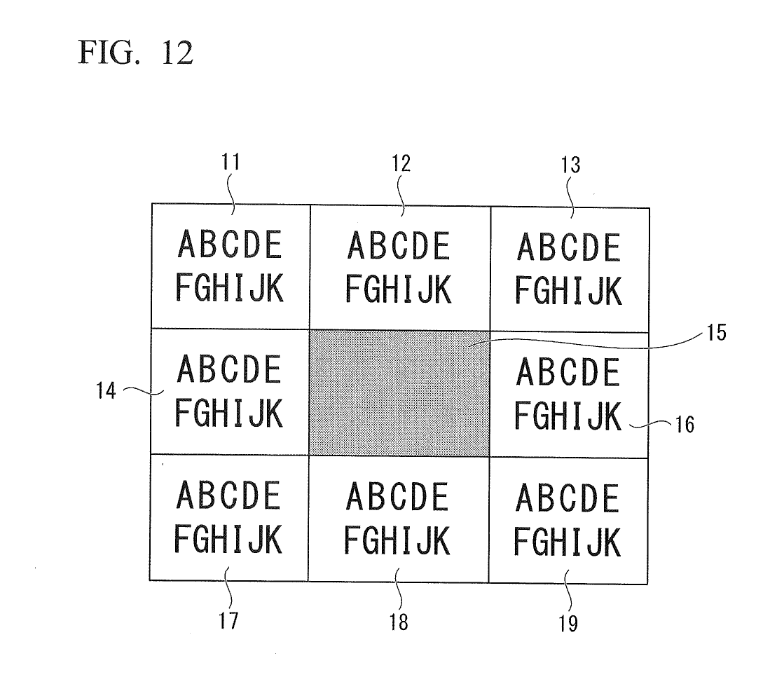

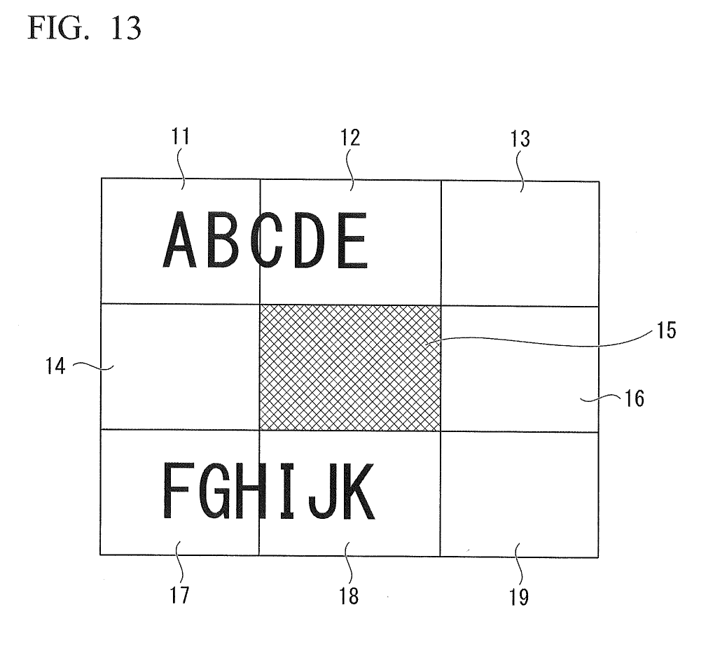

FIGS. 12 and 13 are schematic diagrams that shows examples of the display utilizing the multi-screen display system 1 when any display device has entered the Nondisplay state.

In the control rule table for the example of FIG. 12, the display rule associated with the position ID “5” is “Single-screen display” and the control process applied to other display devices is “Power off”.

According to the display rule called “Single-screen display”, the display control unit 103 displays the image “ABCDEFGHIJK” indicated by the video signal on each of the slave devices 11, 12, 13, 14, 16, 17, 18, and 19, which are display devices in the displayable state, in a single-screen manner. In addition, according to the control process applied to other display devices called “Power off”, the display control unit 103 turns off the power of the slave device 15 which is a display device in the Nondisplay state.

In the control rule table for the example of FIG. 13, the display rule associated with the position ID “5” is “Multi-screen division display” and the control process applied to other display devices is “Monochromatic display (white)”.

According to the display rule called “Multi-screen division display”, the display control unit 103 forms a multi-screen utilizing the master device 11 and the slave devices 12, 17, and 18 and displays the image (that includes the image “ABCDEFGHIJK”) indicated by the video signal on the formed multi-screen. In addition, according to the control process applied to other display devices called “Monochromatic display (white)”, the display control unit 103 displays white over the slave devices 13, 14, 16, and 19, which are other display devices that do not form the multi-screen.

As described above, in accordance with the present embodiment, the master device 11 sends the Nondisplay detection signal to the slave devices 12 to 19 so as to detect each display device in the Nondisplay state. When detecting any device in the Nondisplay state, the multi-screen display system 1 selects a display method associated with the position (i.e., position ID) of the “Nondisplay” display device (i.e., performs switching of the display method) so as to redisplay the image corresponding to the relevant video signal. Therefore, even when part of a plurality of display devices has entered the Nondisplay state, the target image can be accurately displayed. That is, information according to 100 percent of the video signal can be communicated and thus “Proof of Display” can be expected.

A program for executing the individual functions of the master device 11 in FIG. 3 or the slave device 12 in FIG. 4 may be stored in a computer readable storage medium, and the program stored in the storage medium may be loaded and executed on a computer system, so as to perform the relevant display operation. Here, the computer system has hardware resources which include an OS and peripheral devices.

If the computer system employs a WWW system, the computer system can provide a homepage service (or viewable) environment.

The above computer readable storage medium is a storage device, for example, a portable medium such as a flexible disk, a magneto optical disk, a ROM, or a CD-ROM, or a memory device such as a hard disk built in a computer system. The computer readable storage medium also covers a device for temporarily storing the program, such as a volatile storage medium in a computer system which functions as a server or client. In addition, the program may execute part of the above-explained functions, or may be a program by which the above-described functions can be executed by a combination program of this program and an existing program which has already been stored in the relevant computer system. In addition, the above-described program may be stored in a specific server and distributed via a communication line (due to downloading or the like) in response to a request from other devices.

The embodiments of the present invention have been explained in detail with reference to the drawings. However, concrete structures are not limited to the embodiments and also include design modifications or the like, within the scope of the present invention.

For example, the explanation for the above embodiment shows a display control when one of the display devices that form the multi-screen display system 1 is in the Nondisplay state. However, display may be controlled when two or more of the display devices that form the multi-screen display system 1 are in the Nondisplay state.

Additionally, in the above embodiment, the multi-screen display system 1 has an arrangement of 3×3 display devices. However, the present invention can be applied to any multi-screen display system having a greater number (e.g., 4×4 or 4×3) of display devices.

Furthermore, in the above embodiment, each display device functions as the smallest unit. However, the smallest unit may be a specific number of LEDs or pixels so as to perform redisplay by switching the aspect ratio without setting an appropriate multi-screen.

A first embodiment according to the present invention may be a multi-screen display system having a plurality of display devices connected with each other, one of which is a master device that includes:

a detection unit which detects that any one or more of slave devices, which are the display devices other than the master device, are not able to perform display; and

a display control unit that controls display operation of the individual display devices according to a display method associated with a position in the multi-screen display system of each slave device detected by the detection unit.

As a second embodiment according to the present invention, in the multi-screen display system of the first embodiment, it is possible that the master device includes a storage unit that stores a display method which is associated with a position of each slave device and employed when the slave device is not able to perform display; and

the display control unit retrieves the display method associated with the position of the slave device that is not able to perform display and controls the display operation of the individual display devices according to the retrieved display method.

As a third embodiment according to the present invention, in the multi-screen display system of the first or second embodiment, it is possible to send a Nondisplay detection signal, which is utilized to detect each slave device that is not able to perform display, to the individual slave devices and detect each slave device that is not able to perform display based on responses from the slave devices.

As a fourth embodiment according to the present invention, in the multi-screen display system of any one of the first to third embodiments, each slave device who has received the Nondisplay detection signal may send a response signal to the master device.

As a fifth embodiment according to the present invention, in the multi-screen display system of any one of the first to fourth embodiments, when each slave device, which is able to display, receives a redisplay command signal, the slave device may display video according to the redisplay command signal.

As a sixth embodiment according to the present invention, in the multi-screen display system of any one of the first to fifth embodiments, after the master device sends the Nondisplay detection signal to the slave devices, the master device may detect that each slave device, from which no response signal could not be received within a predetermined period of time, is not able to perform display.

As a seventh embodiment according to the present invention, in the multi-screen display system of any one of the first to sixth embodiments, when the slave devices could not receive the Nondisplay detection signal from the master device within a predetermined period of time, they may detect that the master device is not able to perform display. In this case, each slave device may perform display according to a control rule table stored in a storage unit provided in the own device.

An eighth embodiment according to the present invention may be a display method utilized in the multi-screen display system of any one of the first to seventh embodiments.

### REFERENCE SYMBOLS

11 master device
12, 13, 14, 15, 16, 17, 18, 19 slave device
101, 201 storage unit
102 reception unit
103, 203 display control unit
104, 204 display unit
105, 205 connection unit
106, 206 detection unit
107 clocking unit

1. A multi-screen display system having a plurality of display devices connected with each other, one of which comprises a master device that comprises:
a detection unit which detects that any one or more of slave devices, which comprise the display devices other than the master device, are not able to perform display; and
a display control unit that controls display operation of the individual display devices according to a display method associated with a position in the multi-screen display system of each slave device detected by the detection unit.

2. The multi-screen display system in accordance with claim 1, wherein:
the master device comprises a storage unit that stores a display method which is associated with a position of each slave device and employed when the slave device is not able to perform display; and
the display control unit retrieves the display method associated with the position of the slave device that is not able to perform display and controls the display operation of the individual display devices according to the retrieved display method.

3. The multi-screen display system in accordance with claim 1, wherein:
the detection unit sends a Nondisplay detection signal, which is utilized to detect each slave device that is not able to perform display, to the individual slave devices and detects each slave device that is not able to perform display based on responses from the slave devices.

4. A display method utilized in a multi-screen display system having a plurality of display devices connected with each other, the method comprising:
detecting, by a master device, that comprises one of the display devices, that any one or more of slave devices, which comprise the display devices other than the master device, are not able to perform display; and
controlling, by the master device, display operation of the individual display devices according to a display method associated with a position in the multi-screen display system of each detected slave device.
